(19) United States
(12) Patent Application Publication
(10) Pub. No.: US 2010/0159268 A1
(43) Pub. Date: Jun. 24, 2010

(54) METHOD FOR PRODUCING DECORATIVE SURFACE STRUCTURES

(76) Inventor: Andreas Fath, Haslach (DE)

Correspondence Address: DUANE MORRIS LLP - Philadelphia;IP DEPARTMENT, 30 SOUTH 17TH STREET, PHILADELPHIA, PA, 19103-4196, US

(21) Appl. No.: 11/993,435

(22) PCT Filed: Jun. 14, 2006
(86) PCT No.: PCT/EP06/05713

§ 371 Date: Jan. 17, 2008

(30) Foreign Application Priority Data
Jun. 21, 2005 (DE) 10 2005 030 272.6

(51) Int. Cl. B32B 3/10; B05D 3/06; C25D 13/04; C25D 5/02

(52) U.S. Cl. 428/601; 427/532; 427/551; 204/478; 427/554; 427/553; 205/120

(57) ABSTRACT

In the case of a method for producing decorative surface structures, patterns or the like on articles, in particular sanitary articles, basic bodies made of a first metal, basic bodies made of metal that are coated with a first metal or basic bodies made of plastic that are coated with a first metal are used as a basis. Then, a layer of material temporarily applied to the article is partially removed by electromagnetic radiation or by particle radiation, thereby forming a first surface structure with regions that are free from material. Subsequently, the first metal is at least partially removed in the material-free regions or the first metal or some other metal is built up in the material-free regions. This method step is followed by removal of the still present material, a second (final) surface structure being formed. Finally, further top layers can preferably be applied to the article, the second surface structure being substantially retained.

The invention relates to a method for producing decorative surface structures or the like on articles, in particular sanitary articles, and to the corresponding articles themselves.

In a multiplicity of articles, in particular articles of use, not only does their technical function play an important part, but also their design. This also applies particularly to sanitary articles, that is to say to articles which are used in the bathroom and also in the kitchen. These are, for example, valve fittings and showers, such as handshowers, shower heads and the like, but also what may be referred to as bathroom accessories, such as lights, mirrors, repositories and much more.

An agreeable design, in this context, is increasingly implemented not only in the shape of the article alone, but also in the configuration of the surfaces of such articles, whether in the form of surface color, surface structure, surface pattern or the like.

In this respect, it is often desirable for such surfaces to have an in the broader sense “metallic” character. This means that the surface either is to be formed of a metal or should at the very least give the impression that it consists of a metal. Accordingly, nowadays, many sanitary articles which are either manufactured from metal or manufactured, for practical reasons or on cost grounds, from plastic are provided with metallic covering layers. These metallic covering layers then, on the one hand, assume the decorative function referred to and, on the other hand, give the article necessary technical properties, such as corrosion resistance, abrasion resistance, an easy-to-clean function and the like.

Where the metallic covering layers mentioned are concerned, particularly in the case of sanitary articles, chromium plating continues to be a firm favorite. This means that the corresponding articles receive a final chrome surface. These chrome layers may in a known way either be in glossy form (gloss chrome) or be in matt form (matt chrome).

So as to make further decorative surfaces available to the customers, over and beyond the two possibilities of gloss chrome and matt chrome, it is already known to roughen or to brush chrome surfaces or surfaces consisting of other covering metals. Thus, additional surface effects, the number of which is limited, however, can be made available.

Overall, however, there is still the need to make available further surface structures, patterns and the like which are a contrast to the surfaces known hitherto. On the one hand, this is the wish of customers who want to have further options for designing their bathrooms and kitchens. This also applies, however, to the manufacturers who, by providing novel surfaces, can make themselves distinguishable from their competitors. In this respect, of course, it is desirable that the corresponding surface structures can be implemented from a product range for all articles, in particular sanitary articles, in order thereby to have a standard bathroom design, that is to say at least via valve fittings, a wall bar, shower and the like.

Accordingly, the set object of the invention is to provide such novel surface structures on articles, in particular sanitary articles. These surface structures are to be capable of being produced in a comparatively simple way and, as far as possible, of being integrated into existing production and surface treatment methods. It is to be possible to employ these methods for an entire product range, that is to say they are to be employable, as far as possible, for different substrates (metal and plastic).

This object is achieved by means of the method having the features of claim 1. Preferred embodiments of this method are illustrated in the dependent claims 2 to 28. The invention also embraces the correspondingly produced articles which are described in claims 29 and 30 and also in claims 31 to 36 dependent on these. The wording of all the claims hereby, by reference, becomes the content of this description.

In the initially mentioned method for producing decorative surface structures, patterns or the like on articles, in particular sanitary articles, these articles consist either of a (first) metal or of metal or plastic which are coated with at least one (first) metal. According to the invention, a material layer temporarily (that is to say, provisionally) applied to this article is partially stripped off so as to form a first surface structure which then has material-free regions. This stripping off takes place with the aid of electromagnetic radiation or with the aid of particle (corpuscular) radiation. In a further method step, then, in the material-free regions either the first metal (which forms the article or is applied to metal or plastic) is removed at least partially, preferably completely, or the first metal or another metal is built up, for example by deposition, in the material-free regions. After this alternative step carried out in two ways, the material still present, which is still present after the partial stripping off in the first step, is removed so as to form a second surface structure. Then, the method according to the invention is terminated, or at least one further layer may be applied preferably to the second surface structure, this second surface structure being essentially preserved.

According to the invention, various matters and substances may be used as temporarily applied material. In this case, it is expedient to select the material, depending on how the method step following the partial stripping off of the material is configured, that is to say depending on whether, in this further method step, the first metal is removed or the first metal/another metal is built up. In the first instance, the material which remains on the article after the partial stripping off must survive, essentially undamaged, the conditions under which the first metal is removed in the following method step. In the second instance, the material which remains on the surface of the article after the partial stripping off must survive, likewise essentially undamaged, the conditions under which the first metal or another metal is built up in the following method step. This will be explained in more detail below.

Accordingly, according to the invention, in the instances in which the first metal is removed after the stripping off, the temporarily applied material is preferably a metal. This metal is selected, in particular, such that, on the one hand, it can be removed comparatively simply by electromagnetic radiation/particle radiation, but, on the other hand, it has sufficient resistance to the chemical or physical conditions under which the first metal is removed in the following method step. Such a preferred metal is, for example, tin. In these instances, the material, preferably the metal, may be applied, in particular, by means of a deposition operation. A deposition operation from a suspension or solution, which may take place currentlessly or with the aid of a current, is preferred here. In such instances, a currentless deposition of the material, in particular of tin as said preferred metal, is particularly preferred.

In the instances in which the first metal or another metal is built up after the stripping off of the material, the material is preferably an organic substance, in particular a polymer. What are known as e-coats (electrodeposited coats) are preferred here. Such materials are known to a person skilled in the art. These are here, for example, aqueous emulsions which are deposited onto electrically conductive substrates from this emulsion electrophoretically. This, too, is explained in more detail below.

The layer thickness of the temporarily applied material layer may, according to the invention, be varied within broad limits. On the one hand, the material layer should possess a sufficient thickness in order, in the method step following the stripping off, to form the “protective function” for the corresponding regions of the surface. On the other hand, the layer thickness should be as small as possible, in order to make it possible to carry out the partial stripping off by electromagnetic radiation/particle radiation in a simple way. Accordingly, preferred thicknesses for the material layer lie in the μm range, layer thicknesses of <20 μm, in particular of <10 μm, being preferred.

According to the invention, the partial stripping off of the temporarily applied material layer takes place by means of electromagnetic radiation/particle radiation. This radiation must be sufficiently energy-rich to make it possible to strip off the material in the desired way in order to form a first surface structure with material-free regions. For this purpose, basically, any radiation with sufficient energy is suitable, while particular emphasis is to be placed here on UV radiation and laser radiation. In a particular way, according to the invention, the use of laser radiation is suitable, since defined structures and patterns can thereby be produced in a simple way.

The first metal which forms the article or with which the article consisting of metal or plastic is coated is preferably a metal which can be removed comparatively simply from the material-free regions or can be built up comparatively simply in these regions. In the case of sanitary articles in which metallic covering layers are applied during manufacture, preferably by deposition, in particular electro-deposition, it is appropriate to select as first metal those metals which are in any case already integrated into this manufacturing process. Accordingly, the first metal is, in addition to zinc or brass, in particular nickel or copper. Nickel or copper are also the preferred other metals which, in a variant of the method according to the invention, can be built up in the material-free regions. In all instances, particular emphasis must be placed on the use of copper as the first metal, this being, in particular, electro-deposited copper (what is known as bright copper). This is likewise explained in more detail below.

When, in the invention, the first metal is removed in the material-free regions, this stripping off of metal may take place preferably by means of what is known as chemical etching. In this case, a solution is used which peels off the corresponding first metal and transfers it into the solution. This procedure is suitable particularly when copper is used as the first metal. Accordingly, for example, alkaline copper chloride solutions are used in order to peel off copper and thus remove it in the material-free regions.

If the method variant according to the invention in which the first metal or the other metal is built up is selected, this build-up of metal preferably takes place by deposition from a solution. This deposition may take place currentlessly or preferably with the aid of current, that is to say by electrodeposition. Here, too, an electrodeposition of nickel or, in particular, of copper can be implemented in a simple way.

After the first metal is removed or the first metal or the other metal is built up, then, as already mentioned, the material still present is removed so as to form a second surface structure. This removal of the material preferably takes place by means of (chemical) dissolving, which is also designated as “stripping”. For this purpose, conventional solutions may be used, such as are known to a person skilled in the art for the individual substances used as material. Thus, tin can be stripped, for example, by means of solutions containing nitric acid, and e-coats, for example, by means of strong bases.

As already mentioned, in the method according to the invention, finally, preferably at least one further layer is applied to the previously formed second surface structure. In this case, it is of critical importance that this second surface structure is essentially preserved in spite of the application of the further layer.

This further layer is, as a rule, a final covering layer which is applied, in particular, for reasons of corrosion resistance or abrasion resistance or to provide an easy-to-clean function. Thus, it may be, for example, a final layer of polysiloxane, such as is known from the prior art. In particular, however, the further layers are metal layers, preferably chromium plating. For this purpose, in these instances, for example, a nickel layer is first applied, this nickel layer then deliberately containing little or no additives, such as are normally used for leveling the substrate for subsequent chromium plating. The application of the nickel layer is then followed by the subsequent chromium plating which takes place in the usual way. Instead of chromium plating, it is likewise possible to apply final covering layers with the aid of a PVD method (physical vapor deposition). This is expedient, for example, in the case of functional and decorative covering layers consisting of ZrN, TiN, CN or various oxides.

In a development, in the method according to the invention, it is preferable if the articles are the initially mentioned sanitary articles. Reference is made here to the introductory remarks. In particular, these sanitary articles are what are known as valve fittings and showers of all types, such as, for example, handshowers, shower heads and the like. In accordance with the previous statements, these sanitary articles are manufactured from metal, for example from brass or zinc diecasting. This applies particularly to valve fittings. Showers are manufactured, in particular, from plastic, and here, in particular, mention must be made of those consisting of ABS (acrylonitrile/butadiene/styrene copolymer) or ABS/PC (polycarbonate).

In accordance with the previous statements, the following preferred embodiments of the method according to the invention can be defined.

Thus, on the one hand, a method according to the invention is preferred in which the corresponding article, in particular the sanitary article, is manufactured from plastic and is coated with a first metal. A material layer consisting of a further metal is then temporarily applied to this article and is partially stripped off by laser radiation so as to form a first surface structure with material-free regions. The first metal is then at least partially removed by chemical etching in the material-free regions. Thus, after the removal of the material still present, a second (final) surface structure is formed. This may then preferably be provided with at least one further layer, the second surface structure being essentially preserved.

In a second preferred embodiment of the method according to the invention, the article, in particular the sanitary article, is manufactured from brass or zinc diecasting and is subsequently coated with a first metal. A material layer consisting of a further metal is then temporarily applied to this substrate, and this material layer is partially stripped off by laser radiation so as to form the first surface structure with material-free regions. The first metal is then likewise removed by chemical etching in the material-free regions, and the material still present is removed so as to form a second (final) surface structure. Here, too, this second surface structure may be coated over with at least one further layer, this second surface structure being essentially preserved.

In the two method managements last described, the first metal is preferably nickel or, in particular, copper, and finally first a nickel layer and subsequently a chrome layer are applied as further layers.

In an alternative management of the method, the article, in particular the sanitary article, likewise consists of brass or zinc diecasting. Here, however, the brass or zinc itself is the first metal defined according to the invention, that is to say no further metal layers are applied to the brass or zinc. Then, according to the invention, a metal is temporarily applied as a material layer to the brass or zinc substrate. The article thus coated is then treated by laser radiation, that is to say the material layer is partially stripped off so as to form a first surface structure with material-free regions. The removal of the brass or zinc (here, the first metal) by chemical etching then likewise takes place. Subsequently, likewise, the material still present is removed so as to form a second (final) surface structure, and preferably at least one further layer is applied to this surface structure, this second surface structure being essentially preserved. Here, too, an application of first nickel and then chrome as a further layer and consequently final covering layer is preferred.

In another group of preferred embodiments of the method according to the invention, the article, in particular sanitary article, likewise consists of plastic and is coated with a first metal. An organic material is then temporarily applied to the article and is subsequently partially stripped off by laser radiation so as to form a first surface structure with material-free regions. A build-up of the first metal then takes place in the material-free regions by deposition, preferably by electrodeposition. The material still present is then removed so as to form a second (final) surface structure, and preferably at least one further layer is applied to this surface structure, the second surface structure being essentially preserved.

In a further preferred method variant according to the invention, an article, in particular a sanitary article, which is manufactured from brass or zinc, is taken as a starting point. A layer comprising a first metal is located on this article. An organic material is then likewise temporarily applied to the article and this material layer is partially stripped off by laser radiation so as to form a first surface structure with material-free regions. Here, too, the build-up of the first metal then subsequently takes place by deposition, preferably electrodeposition. After the material still present has been completely removed, during which time a second (final) surface structure is formed, preferably at least one further layer is then applied. In this case, the second surface structure is essentially preserved.

In the two last-mentioned embodiments, the first metal is preferably nickel or, in particular, copper. As further layers, first nickel and then chrome are applied.

In a further preferred alternative of the method according to the invention, an article, in particular a sanitary article, consisting of brass or zinc diecasting is taken as a starting point, no further metal layer being located on this article. The brass or zinc is therefore itself the first metal, as defined according to the invention. An organic material is then temporarily applied to the article, the material layer formed then being partially stripped off by laser radiation so as to form a first surface structure with material-free regions. A metal (another metal) is then deposited onto this first surface structure in the material-free regions, preferably by electrodeposition. The procedure then continues in the way already described, that is to say, first, the material still present is removed so as to form a second (final) surface structure, and subsequently at least one further layer is applied, this second surface structure being essentially preserved.

In the alternative outlined last, the other metal is preferably nickel or, in particular, copper. As further layers, preferably first nickel and then chrome are applied.

The method according to the invention, as outlined, in particular the preferably mentioned method variants, have a whole series of advantages, as compared with the prior art. Thus, any desired surface structures, surface patterns or the like can be provided in the way outlined. These structures are first defined by the partial stripping off of the temporarily applied material layer (first surface structure). Then, depending on the article (substrate), various variants may be selected. Either the (first) metal is removed or the first metal or another metal is built up in the material-free regions. Correspondingly, the first surface structure is converted into a second surface structure, this second surface structure forming the final surface structure. Either the build-up thus obtained is the final product or this build-up may be converted into the final product with the aid of further covering layers. In this case, the second surface structure is then preserved.

Since the method according to the invention can be carried out, starting from various substrates, it is possible to generate an identical (second) surface structure on various substrates. This permits the production of a product range consisting of various substrates with an identical surface structure. As already outlined, this is highly advantageous, precisely in the sanitary sector, since, here, products sold together and consisting of different substrates are produced, for example valve fittings made from metal (brass, zinc diecasting) and showers made from plastic.

In addition to the method according to the invention, the invention also embraces the articles themselves, in particular the sanitary articles mentioned, which are obtained and obtainable by means of the method.

Accordingly, particular emphasis is to be placed as preferred products upon:
an article according to the invention made from plastic with a coating consisting of a first metal which carries the corresponding structure (second surface structure). Preferably at least one further layer, preferably a chrome layer, is then located above this structured first metal.
In accordance with the disclosure with regard to the method claims, a layer consisting of another metal may also be located above the layer consisting of the first metal, the second (final) surface structure then being formed together by the first metal and by the other metal.
An article according to the invention made from brass or zinc diecasting which has on its surface a structured layer consisting of a first metal (second surface structure). Here, too, at least one further layer, in particular a chrome layer, may preferably be located above this layer consisting of the first metal.
Here, too, in special versions, the second surface structure may be formed together by the first metal and by another metal arranged above the first metal.

In the case of the two preferred articles mentioned, the first metal is preferably nickel or, in particular, copper. Further, it must be emphasized that a nickel layer may be located below the final chrome layer.
In the case of a third preferred article according to the invention, this is an article which is manufactured from brass or zinc diecasting. Here, a structuring (second surface structure) is present in this brass or zinc diecasting itself. If appropriate, the second surface structure is formed by the brass or zinc together with another metal which has been built up on it, preferably nickel or copper. Preferably at least one further layer, which essentially preserves the second surface structure, may then be located above it. Here, too, the further layer may be, in particular, chromium plating, in which case, in particular, a nickel layer may be arranged below the chrome layer.

The features described and further features of the invention may be gathered from the following description of preferred embodiments, in conjunction with the subclaims and the drawings. In this case, the individual features may in each case be implemented in themselves or severally in combination with one another.

In the drawings:

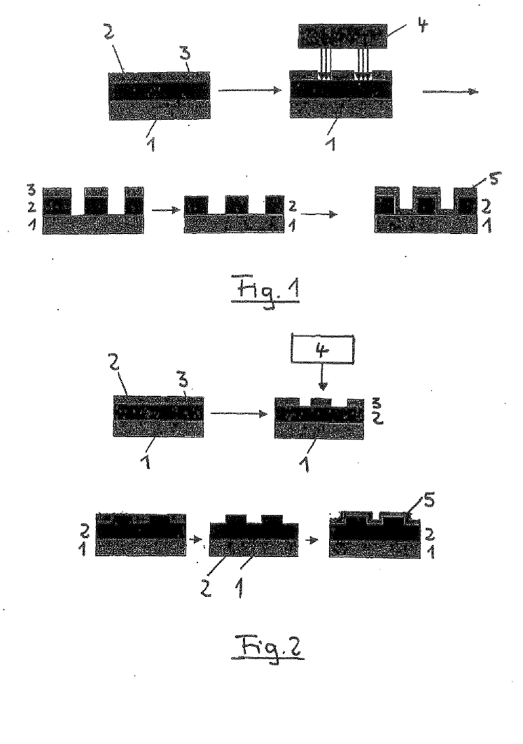

FIG. 1 shows a diagrammatic illustration of a method sequence of a first version of the method according to the invention,

FIG. 2 shows a diagrammatic illustration of a method sequence of a second version of the method according to the invention.

In the management of the method according to FIG. 1, a layer 2 consisting of a first metal, in particular of copper, is located on an article 1 (substrate) which may consist of metal, in particular brass or zinc diecasting, or of plastic, in particular ABS or ABS/PC. This copper layer may be electro-deposited onto the substrate, in particular in the form of bright copper.

Above the layer 2 is located a further metal layer 3 as a temporarily applied material layer within the meaning of the invention. This is, in particular, a layer consisting of tin which is applied currentlessly from a solution. This build-up consisting of the article 1 (substrate), layer 2 consisting of a first metal, and temporarily applied metal layer 3 constitutes the starting point for the further method sequence illustrated in FIG. 1.

Thus, first, part of the metal layer 3 is stripped off with the aid of a laser 4. This stripping off takes place according to instructions, for example by computer control, in order thereby to produce a specific structure or a specific pattern with regions on which a metal layer 3 is no longer present. This structure or this pattern is then the first surface structure, already discussed in detail, on the article.

In a next method step, the layer 2 consisting of the first metal (preferably copper) is then removed at the locations at which a material layer/metal layer 3 is no longer present. This takes place preferably by means of what is known as chemical etching, which can be implemented, in the case of copper as the first metal, particularly simply by means of an alkaline copper chloride solution.

Then, in a further method step, the material layer/metal layer 3 which has still remained is removed, preferably by what is known as stripping by means of a corresponding solution. This gives rise on the article 1 to a second (final) surface structure which is formed by the remaining layer 2 consisting of the first metal and parts of the surface of the article (substrate). This build-up may, for specific applications, then already constitute the final product of the method according to the invention, as shown in FIG. 1.

Preferably, the build-up obtained, having the second surface structure, is treated further by the application of at least one further covering layer 5. Such a covering layer 5 may be, for example, a polysiloxane layer. In particular, however, the build-up obtained, having the second surface structure, is chromium-plated, in which case, as a rule, first a nickel layer and then a final chrome layer are applied. This is likewise illustrated diagrammatically in FIG. 1. It can also be seen from the corresponding illustration that, when final covering layers 5 are applied, the second surface structure is essentially preserved.

In the second preferred method variant of the invention according to FIG. 2, as a rule, an article 1 made from metal, in particular from brass or zinc diecasting, or from plastic, in particular from ABS or ABS/PC, is likewise taken as a starting point. A layer 2 consisting of a first metal is likewise located on this article 1, a layer 2 consisting of copper likewise being preferred here. A material layer 3 consisting of an organic material, in particular of an organic polymer, is located on this layer 2. This build-up is then taken as a starting point for the further management of the method.

In this case, first (as illustrated in FIG. 1), part of the material layer 3 is stripped off by laser radiation. According to the selected instruction, this likewise gives rise to a first surface structure with regions in which the material layer 3 is no longer present.

Starting from this first surface structure, in the procedure according to FIG. 2, metal is then built up in the material-free regions of the material layer 3, in contrast to the procedure according to FIG. 1. This metal may preferably be the first metal itself, that is to say the metal of the metal layer 2, or another metal. The build-up of the metal in the material-free regions of the material layer 3 preferably takes place by deposition, preferably by deposition from a solution. In this case, in particular, electrodeposition is preferred, as well as currentless deposition. In these instances, the material layer 3 which has remained partially on the metal layer 2 ensures that metal deposition takes place actually only in the material-free regions.

After the build-up of the metal in the material-free regions, the material layer 3 which has still remained is removed by what is known as stripping, that is to say, as a rule, by chemical dissolving. This gives rise to a second (final) surface structure which is formed by parts of the surface of the metal layer 2 and by the additional surfaces of the metal deposited on them.

Here, too, the build-up obtained after stripping may constitute the final product of the method according to the invention. Here, too, however, it is preferable if at least one further (covering) layer 5 is applied to the build-up thus obtained, the second surface structure being essentially preserved. This is likewise illustrated in FIG. 2. As regards the covering layers which can be used, reference is made to the corresponding descriptions outlined in connection with FIG. 1.

With reference to FIGS. 1 and 2, method variants which are not illustrated expressly in these figures will also be dealt with below. Thus, when an article 1 (substrate) made from metal, in particular brass or zinc diecasting, is used, it is possible to dispense with the metal layer 2. Within the meaning of the invention, the metal of the article 1 then itself forms what is known as the first metal.

In these instances, the material layer 3 is then applied directly to the article 1, and the material layer 3 is partially stripped off by laser radiation so as to form a first surface structure with material-free regions. Then, in a further method step, either the metal forming the article 1 is removed in the material-free regions or this metal or another metal is built up in the material-free regions. In the first instance, therefore, for example, etching takes place directly into the article 1 in the material-free regions, in order thereby to produce the second surface structure. Or the metal which forms the article 1 or another metal, preferably copper, is built up in the material-free regions. This may take place, for example, by means of the electrodeposition already described. The articles thus obtained may preferably also be provided with the covering layers already outlined.

### EXAMPLES

### Example 1

A method management, such as is illustrated in FIG. 1, may proceed as follows.

A handshower is manufactured in the conventional way by injection molding from ABS (acrylo-nitrile/butadiene/styrene copolymer) or from ABS/PC (polycarbonate). This plastic article is then introduced in the conventional way into an electro-plating plant. There, the article is treated by a conventional method up to the stage of electrochemical coppering (electrocoppering). This means that, in the conventional way, the surface is pretreated, then nickel-plated chemically, pre-nickel-plated and finally coppered. These method steps are known to a person skilled in the art and therefore do not have to be explained in detail here. Chemical nickel-plating takes place, for example, by means of commercially available chemical nickel solutions, such as are offered by the company Enthone, Langenfeldt. Pre-nickel-plating, as it is known, takes place, as a rule, in what are known as sulfamate nickel baths. Coppering is a bright coppering step in sulfuric acid bright copper electrolytes, such as are likewise offered, for example, by the company Enthone.

In contrast to the further method steps known hitherto, the article 1 thus obtained, having the copper layer 2, is chemically tinned in order to apply the material layer 3. For this purpose, a commercially obtainable solution (Tinposit LT-34 of the company Rohm and Haas) is used. The tin layer 3 thus obtained possesses a layer thickness of between 0.5 and 2 μm. According to the manufacturer's instructions, it is applied to the copper layer 2 in an immersion method with an exposure time of 10 to 20 minutes and with a working temperature of between 25° C. and 70° C.

The tin layer 3 is then locally evaporated (ablated) with the aid of an Nd-YAG laser (the company Trumpf, Germany) so as to form the first surface structure. For this purpose, the wavelength of 1.064 nm and feed speeds of 1.000 mm/s may be used. This procedure gives rise to tin-free regions in which the tin is stripped off down to the copper layer 2. The most diverse possible structures and patterns can be produced in this way, which may be in both small-area and large-area form. These may be abstract structures and patterns, a sequence of regular geometric structures, such as squares, but also emblems, lines of characters and the like.

The copper layer exposed in the material-free regions is then, in a next method step, deep-etched, that is to say essentially completely removed, with the aid of a copper etching solution. The etching solution used is an ammoniacal copper (II) chloride solution. This etching solution is copper-selective, so that the remaining tin layer 3 is not attacked. Furthermore, in the layer sequence selected in the example, the nickel layer from pre-nickel-plating, lying below the copper layer 2, functions as a stop layer for the etching operation. This results in a homogeneous etching depth which is predetermined over the copper layer thickness which is largely freely selectable. Conventional layer thicknesses for the copper layer 2 are in the μm range, preferably in the range of between 10 and 20 μm. In the case of such preferred layer thicknesses, the etching operation is usually concluded within periods of between 1 minute and 5 minutes of exposure time.

Subsequently, the remaining tin layer 3 is dissolved by means of what is known as a tin stripper within 1-2 minutes at room temperature. A product of this type is offered, for example, by the company Rohm and Haas under the designation Tinstripper 3055. A structured surface (second surface structure) then remains, which may be provided with further covering layers. In the present instance, after an acid activation step, chromium-plating is carried out in the conventional way, first a bright nickel layer and then a bright chrome layer being applied. In such a bright nickel bath, either the use of what are known as leveling agents is dispensed with entirely or their concentration is reduced, so that the second surface structure and its contours are preserved.

Instead of a handshower made from plastic, the method according to Example 1 may also be carried out in the same way on an article made from metal. This may be, for example, a sanitary fitting made from brass or zinc diecasting. In this instance, for reasons of surface treatment, the application of a bright copper layer 2 is not absolutely necessary. According to the invention, however, it is appropriate first to apply a copper layer 2 even to such articles. Thus, after the introduction of the first surface structure, a comparatively simple operation for etching the copper with a defined etching depth can be carried out. Basically, however, as already explained, it is also possible to etch directly into the basic metal body consisting, for example, of brass or zinc diecasting, after a first surface structure has been produced in a material layer applied directly to the metal body.

### Example 2

A method management according to FIG. 2 likewise starts from a bright-coppered handshower, such as is described in connection with Example 1.

After the electrocoppering step, the coppered component is coated with what is known as an e-coat (electro-deposited coating) as a material layer 3. Here, for example, the product Blackbird XP-0621 of the company Rohm and Haas may be used. Depending on the procedure, this product may be applied to the copper layer 2 on the article 1 (substrate) in layer thicknesses of between 4 and 10 μm.

A first surface structure is then produced by laser radiation (apparatus and procedure according to Example 1). According to Example 2, instead of the tin (Example 1), the organic e-coat is then evaporated (ablated) down to the copper lying beneath it.

The copper exposed in the material-free regions then serves as a starting layer for an electro-deposition of further copper. By means of a conventional electroplating copper bath, the material-free regions lasered free, the depth of which is dependent on the layer thickness of the material layer 3, are filled with copper. The remaining material layer consisting of the e-coat is then peeled off (stripped) by means of a 0.6 to 0.9% NaOH solution at 50 to 60° C. and with an exposure time of 3 to 5 minutes. A second (final) surface structure is thereby obtained. This is then provided with a final chrome layer in a similar way to the procedure in Example 1.

It will be appreciated, here too, that the method management according to Example 2 may also be carried out on an article made from metal, in particular from brass and zinc diecasting. Here, too, it is preferably appropriate first to apply a copper layer 2 to this metal article. However, the method may also be carried out directly on the metallic basic body (substrate), in which case the basic body itself then serves as a starting layer for an electrodeposition of, for example, copper.

What is claimed is:

1. A method for producing decorative surface structures, patterns or the like on articles having a first metal on at least a surface coating thereon, wherein:
at least one material layer applied temporarily to the article is partially stripped off by one of electromagnetic radiation and particle radiation so as to form a first surface structure with material-free regions,
the material-free regions are one of at least partially removed of said first metal and built up with one of the first metal and of another metal in the material-free regions,
material that is still present is removed so as to form a second surface structure, and
at least one further layer is applied, with the second surface structure being essentially preserved.

2. The method as claimed in claim 1, wherein the temporarily applied material comprises a metal.

3. The method as claimed in claim 2, comprising applying the material by currentless deposition.

4. The method as claimed in claim 1, wherein the temporarily applied material comprises an organic material.

5. The method as claimed in claim 4, comprising applying the material by electrophoretic deposition.

6. The method as claimed in claim 1, wherein a thickness of the temporarily applied material layer amounts to less than 20 μm.

7. The method as claimed in claim 1, comprising stripping off the material using one of electron-beam radiation, UV radiation and laser radiation.

8. The method as claimed in claim 1, wherein the first metal comprises at least one or copper, nickel, zinc and brass.

9. The method as claimed in claim 1, comprising removing the first metal in the material-free regions by chemical etching.

10. The method as claimed in claim 1, comprising building up said one of the first metal and of the other metal in the material-free regions by deposition.

11. The method as claimed in claim 1, comprising aiding the removal of the material so as to form the second surface structure using a liquid solution for stripping.

12. The method as claimed in claim 1, wherein the further layer comprises a metal layer.

13. The method as claimed in claim 12, wherein the metal comprises a noble metal.

14. The method as claimed in claim 12, wherein the metal layer is applied by one of deposition from a solution and physical vapor deposition.

15. The method as claimed in claim 1, wherein the sanitary article comprises one of a valve fitting and a shower.

16. The method as claimed in claim 1, wherein the article is plastic coated with at least one said first metal,
the material layer temporarily applied to the article is partially stripped off by laser radiation so as to form the first surface structure with material-free regions,
the first metal is at least partially removed in the material-free regions,
the material still present is removed so as to form the second surface structure, and
at least one further layer is applied, the second surface structure being essentially preserved.

17. The method as claimed in claim 1, wherein the article comprises at least one of brass and zinc coated with at least one said first metal,
the material temporarily applied to the article is partially stripped off by laser radiation so as to form the first surface structure with material-free regions,
the first metal is at least partially removed in the material-free regions,
the material still present is removed so as to form the second surface structure, and
at least one further layer is applied, the second surface structure being essentially preserved.

18. The method as claimed in claim 16, the first metal comprises one of copper and nickel.

19. The method as claimed in claim 16, wherein first nickel and subsequently chrome are applied as the further layer.

20. The method as claimed in claim 1, wherein the article comprises one of brass and zinc as the first metal,
the material temporarily applied to the article is partially stripped off by laser radiation so as to form the first surface structure with material-free regions,
said one of brass and zinc is at least partially removed in the material-free regions,
the material still present is removed so as to form the second surface structure, and
at least one further layer is applied, the second surface structure being essentially preserved.

21. The method as claimed in claim 20, wherein first nickel and then chrome are applied as the further layer.

22. The method as claimed in claim 1, wherein the article comprises plastic coated with the at least one first metal, the material layer temporarily applied to the article is partially stripped off by laser radiation so as to form the first surface structure with material-free regions,
said one of the first metal and another metal is built up in the material-free regions by deposition,
the material still present is removed so as to form the second surface structure, and
at least one further layer being applied, the second surface structure being essentially preserved.

23. The method as claimed in claim 1, wherein the article comprises one of brass and zinc coated with the at least one first metal,
the material layer temporarily applied to the article, comprises an organic material that is partially stripped off by laser radiation so as to form the first surface structure with metal-free regions,
said one of the first metal and another metal is built up in the material-free regions by electrodeposition,
the material still present is removed so as to form the second surface structure, and
the at least one further layer is applied, the second surface structure being essentially preserved.

24. The method as claimed in claim 22 wherein the first metal comprises one of copper and nickel.

25. The method as claimed in claim 22, wherein first nickel and then chrome are applied as the further layer.

26. The method as claimed in claim 1, wherein the article comprises one of brass and zinc as the first metal,
the material layer temporarily applied to the article comprises organic material and is partially stripped off by laser radiation so as to form the first surface structure with metal-free regions,
said one of the first metal and another metal is built up in the material-free regions by electrodeposition,
the material still present is removed so as to form the second surface structure, and
at least one further layer is applied, the second surface structure being essentially preserved.

27. The method as claimed in claim 26, wherein said another metal comprises one of copper and nickel.

28. The method as claimed in claim 26, wherein first nickel and then chrome are applied as the further layer.

29. An article produced according to the method of claim 1.

30. An article having one of a decorative surface structure and pattern, comprising:
a first metal on at least a surface coating the article,
at least one material layer partially stripped off and defining a first surface structure with material-free regions,
wherein the material-free regions are one of at least partially free of said first metal and built up with one of the first metal and another metal in the material-free regions,
a second structure formed at which said material is removed, and
at least one further layer is applied, with the second surface structure being essentially preserved.

31. The article of claim 30, comprising plastic having on its surface at least one structure, defined by a structured layer comprising at least one metal, and at least one further layer following the structure on the surface being present above the metal layer.

32. The article of claim 30, comprising one of brass and zinc, having on its surface at least one structure defined by a structured layer comprising at least one metal, and at least one further layer following the structure on the surface being present above the metal layer.

33. The article as claimed in claim 31, wherein the metal comprises one of copper and nickel.

34. The article as claimed in claim 31, wherein first nickel and then chrome are applied as the further layer.

35. The article of claim 30, comprising a sanitary article, wherein the sanitary article comprises one of brass and zinc having on its surface at least one of a structure and a pattern and at least one further layer following the surface structure being present.

36. The article of claim 35, wherein the further layer comprises layers of first nickel and then chrome.

37. The method as claimed in claim 23, wherein in that the first metal comprises one of copper and nickel.

38. The method as claimed in claim 23, wherein first nickel and then chrome are applied as the further layer.

39. The article as claimed in claim 32, wherein the metal comprises one of copper and nickel.

40. The article as claimed in claim 32, wherein first nickel and then chrome are applied as the further layer.
